(19) United States
(12) Patent Application Publication
(10) Pub. No.: US 2016/0199869 A1
(43) Pub. Date: Jul. 14, 2016

(54) SPRAYER FOR A LIQUID COATING PRODUCT AND SPRAYING FACILITY COMPRISING SUCH A SPRAYER

(71) Applicant: SAMES TECHNOLOGIES, Meylan (FR)

(72) Inventors: Denis Vanzetto, Echirolles (FR); Eric Prus, Grenoble (FR)

(21) Appl. No.: 14/909,773

(22) PCT Filed: Aug. 12, 2014
(86) PCT No.: PCT/EP2014/067251

§ 371 Date: Feb. 3, 2016

(30) Foreign Application Priority Data
Aug. 13, 2013 (FR) 1357992

(51) Int. Cl. B05B 15/04; B05B 17/06

(52) U.S. Cl. CPC B05B 15/0431; B05B 17/0607

(57) ABSTRACT

This sprayer gives the possibility of projecting a liquid coating product along a spraying axis, and comprises a first passage of a product sheet, which is centered on the spraying axis, and a second passage for ejecting an air sheet which co-axially surrounds the first passage. The sprayer further comprises a third passage for ejecting another air sheet which is co-axially positioned inside the first passage, a nozzle centered on the spraying axis, and a core, co-axially positioned inside the nozzle so that the first passage is defined between the core and the nozzle. The sprayer further comprises a vibrator which is capable of vibrating at least the nozzle or the core.

The invention relates to a sprayer for a liquid coating onto a part and a spraying facility equipped with such a sprayer.

The invention finds an application in the field of the coating of parts. In particular, sprayers are often used in the automotive industry for coating bodies with paint and developments have led to their use in sol-gel methods.

Sol-gel methods inter alia give the possibility of forming a mineral or organo-mineral layer without resorting to melting. These methods applying a sol formulated from inorganic or hybrid precursors prepared in a solvent by means of a chemical treatment which may notably include decomposition by hydrolysis, a variation of temperature, decomposition by hydrolysis or further a variation of pH. This sol is deposited in thin layers on the substrate to be coated and the solvent is evaporated so that the layer gels in a crystalline or amorphous layer, such as a glass, ceramic or even glass-ceramic layer.

In these methods, the most delicate part is the deposition of the sol layer. This deposition is achieved with known quenching or centrifugal coating techniques. Now, these techniques are difficult to apply for parts of large dimensions such as a windscreen. This is why the sprayers of liquid coating form an interesting alternative to these deposition techniques. However, the sol layer should be thin and uniform, with high finishing quality, which is difficult to obtain with traditional sprayers.

Traditional guns with a flat jet or with a rotary bowl have the advantage of forming a liquid sheet in which the droplets have a globally homogenous size and distribution within the liquid sheet. On the other hand, this type of gun provides relatively low jet stability since the paint sheet is not guided during the spraying. This latter aspect leads to a coating which is not strictly uniform on the part to be treated.

Sprayers or guns of the <<vortex>> type are known for providing better stability of the jet. Indeed, these guns have the particularity that the liquid jet is exteriorly sheared by a high pressure air sheet. This drives the liquid jet into rotation around a central spraying axis, which improves the stability of the jet.

However, the paint particles close to the interior surface of the jet are subject to less shearing as compared with those located at the periphery of the jet. The size of the droplets and their distribution are therefore not homogenous within the jet, which causes a finishing quality which is not acceptable for applications like applying a paint coating on an automobile body or a sol layer in a sol-gel process.

In order to ensure better distribution of the droplets and a more homogenous size of droplets, from FR-A-2 410 514 an electrostatic sprayer is known, comprising, in addition to a first passage for ejecting an air sheet surrounding the passage of the product, a second passage for ejecting an internal air sheet. The first passage is defined between a core and a nozzle of the sprayer, the core being positioned co-axially inside the nozzle.

Thus, the internal and external air sheets pinch and refine the product sheet. This pinching results in greater spraying fineness. Further, the frictional forces which occur at the interface between the sheet of product and both air sheets generate perturbations within the product sheet, which generate the formation of fine droplets by spraying. The fact of spraying the paint with two air sheets provides better finishing quality. Finally, the frictional forces applied on either side of the product sheet are at the origin of a size and of a distribution of droplets which are more homogenous within the product sheet.

Nevertheless, the size of the droplets is not controlled, so that it is not possible to adapt the size of the droplets according to the type of coating to be made.

These are the drawbacks which the invention intends to remedy more particularly by proposing a sprayer giving the possibility of adapting the size of the sprayed droplets.

For this purpose, the invention relates to a sprayer of a liquid coating product along a spraying axis, comprising a first passage for a product sheet, which is centered on the spraying axis, and a second passage for ejecting an air sheet which surrounds co-axially the first passage. This sprayer further comprises a third passage for ejecting another air sheet which is positioned co-axially inside the first passage, a nozzle centered on the spraying axis, and a core, positioned co-axially inside the nozzle so that the first passage is defined between the core and the nozzle. According to the invention, the sprayer further comprises a vibrator which is capable of vibrating at least the nozzle or the core.

By means of the invention, it is possible to cause vibration of the nozzle and/or the core, which gives the possibility of breaking down the product sheet into droplets on the one hand and of controlling the size of the thereby formed droplets on the other hand by adjusting the frequency of the vibrations. According to advantageous but non-mandatory aspects of the invention, a sprayer may incorporate one or several of the following features, taken in any technically admissible combination:
During operation, the third passage imparts to the other air sheet a divergent direction, with respect to the spraying axis, in the direction of the spraying.
During operation, the second passage imparts to the air sheet a divergent direction, with respect to the spraying axis, in the direction of the spraying.
During operation, at least one passage among the second passage and the third passage imparts to the air sheet or to the other air sheet a helical direction with respect to the spraying axis.
The sprayer comprises a chamber in which open at least one air supply conduit, along an axial direction, and at least one second air supply conduit, along an ortho-radial direction with respect to the spraying axis, and which supplies the second passage.
Alternatively, the sprayer comprises a chamber which is supplied by an air supply conduit and air ejection holes which are supplied by this chamber and which, during operation, supply together the air sheet.
The vibrator uses an ultrasound technology.
The core is extended along the spraying axis and beyond the nozzle by a bowl.
The bowl has the shape of a bell which diverges, relatively to the spraying axis, in the direction of the spraying.
The inside of the bowl may be cleaned by injecting a rinsing product in the third passage.

The invention also relates to a facility for spraying a liquid coating product onto a part, this facility comprising a confinement chamber, a product supply block, an electro-pneumatic control box, and at least one sprayer of the product. According to the invention, the sprayer of this facility is as described earlier.

According to an advantageous aspect, but not mandatory, the facility comprises means for adjusting the air flow in the first conduit and in the second conduit.

The invention will be better understood and other advantages thereof will become more clearly apparent in the light of the description which follows of four embodiments of a sprayer in accordance with its principle, only given as an example and made with reference to the appended drawings wherein:

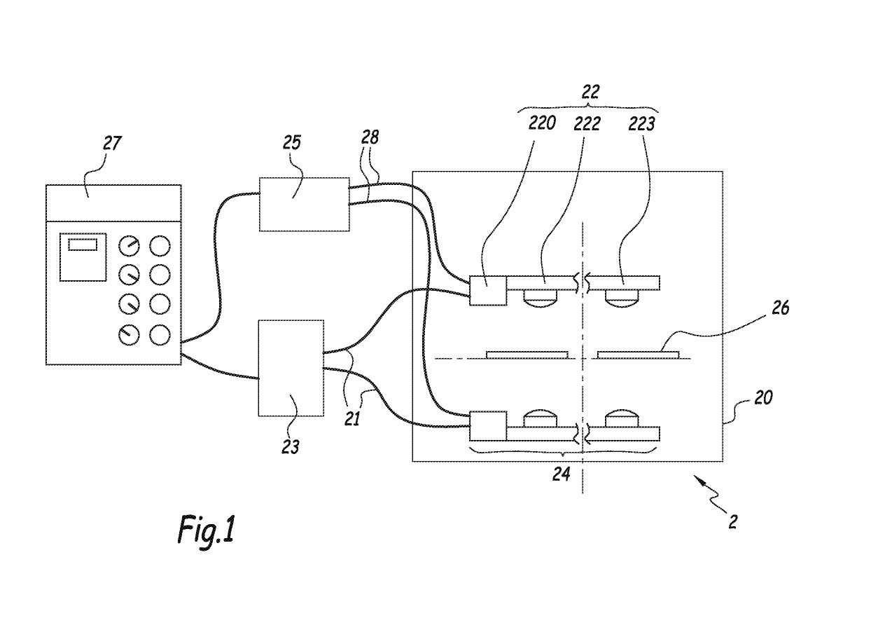

FIG. 1 is a schematic view of a facility for spraying a liquid coating product according to the invention,

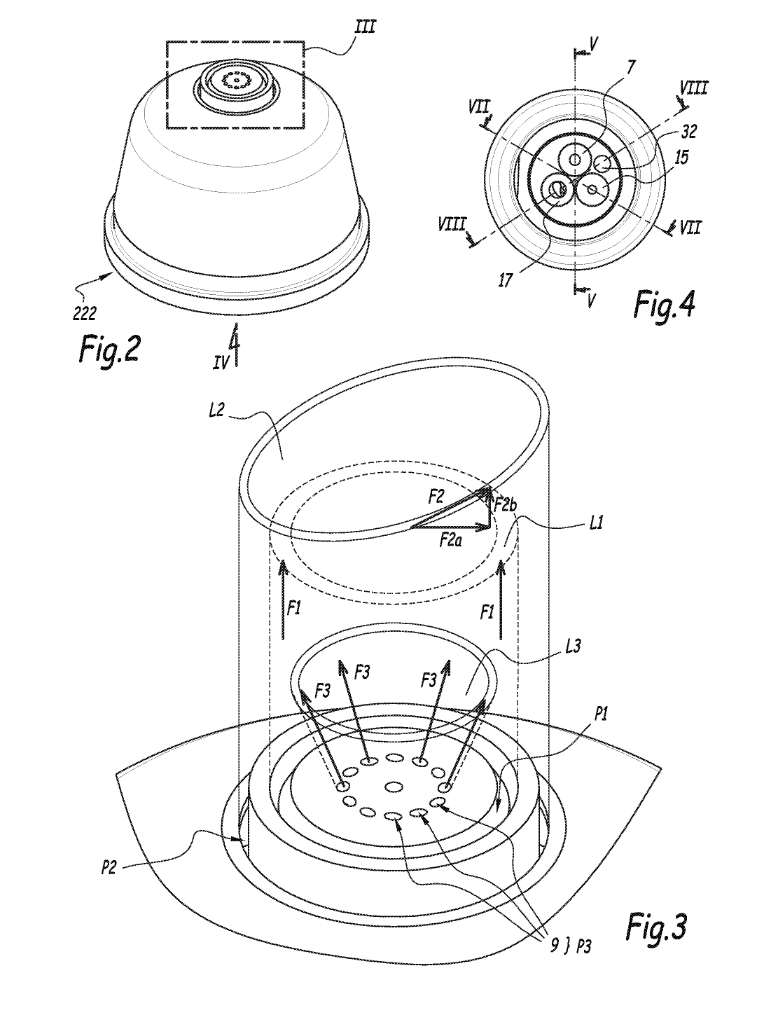

FIG. 2 is a perspective view of a module of a sprayer in accordance with the invention belonging to the facility of FIG. 1,

FIG. 3 is a view at a larger scale of the frame III of FIG. 2,

FIG. 4 is a view along the arrow IV of FIG. 2,

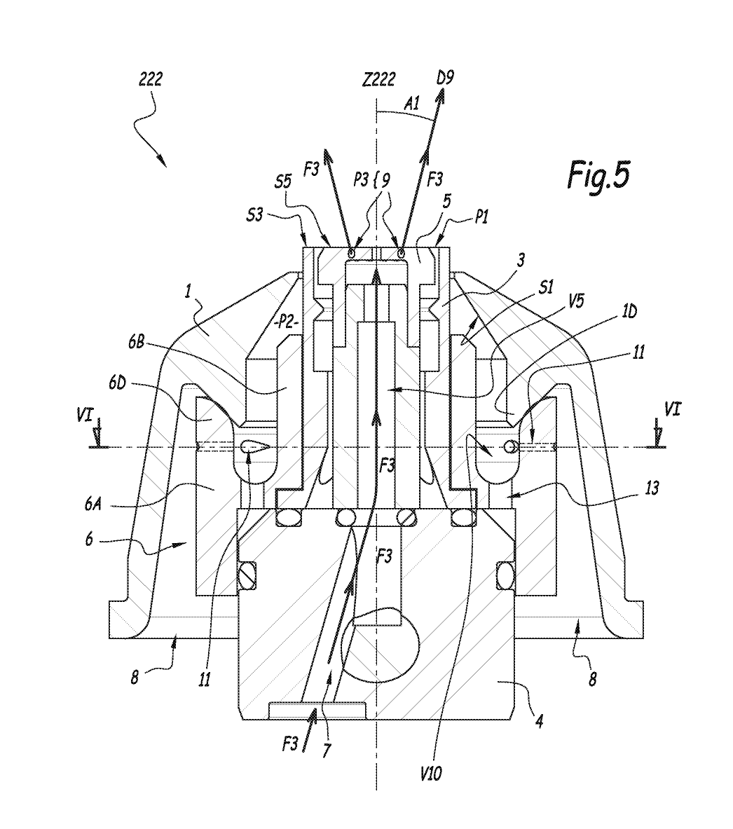

FIG. 5 is a sectional view at a larger scale along the line V-V of FIG. 4,

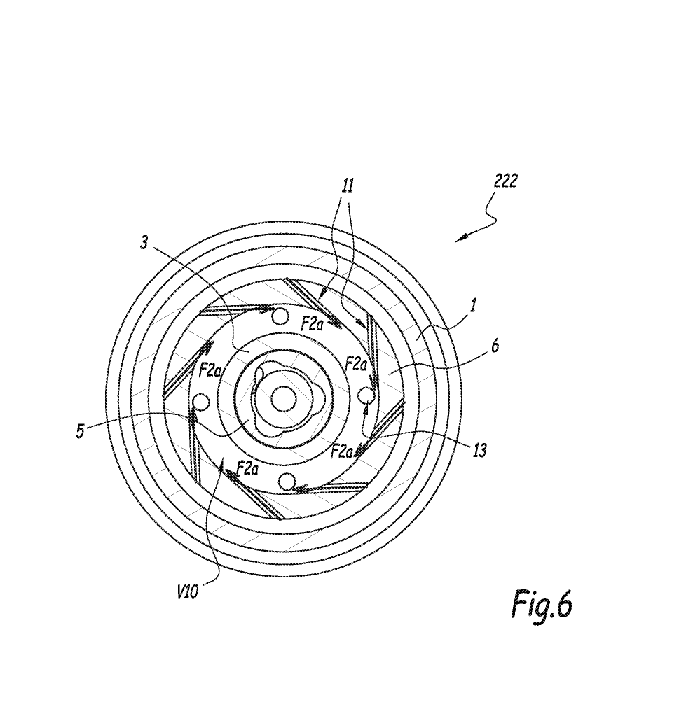

FIG. 6 is a sectional view at a smaller scale along the line VI-VI of FIG. 5,

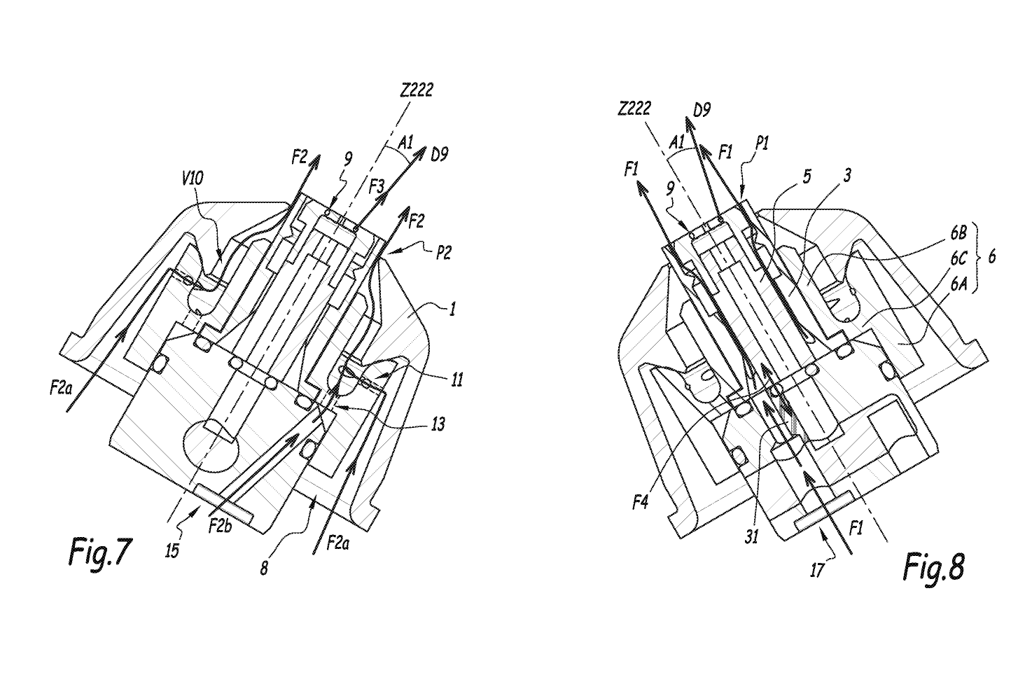

FIGS. 7 and 8 are sectional views at a larger scale along the lines VII-VII and VIII-VIII of FIG. 4,

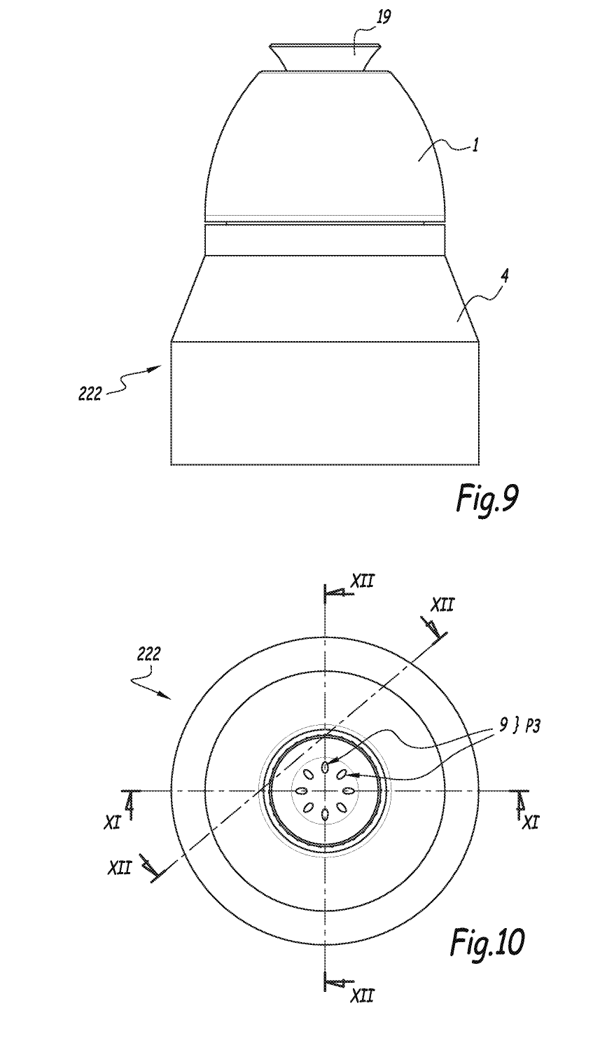

FIG. 9 is a side view of a sprayer according to a second embodiment of the invention,

FIG. 10 is a view along the arrow X of FIG. 9,

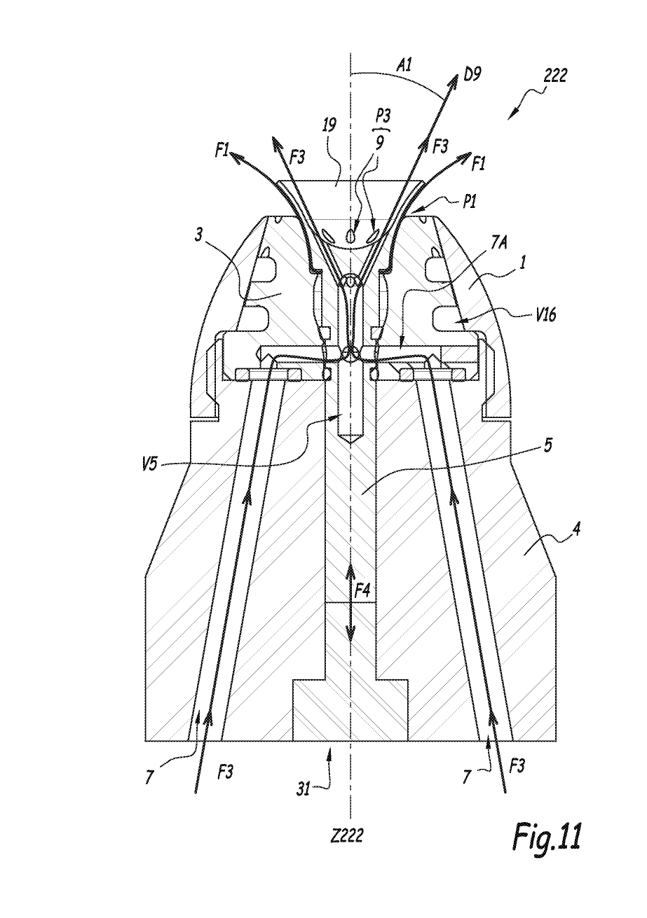

FIGS. 11 and 12 are sectional views at a larger scale, along the lines XI-XI and XII-XII of FIG. 10, respectively,

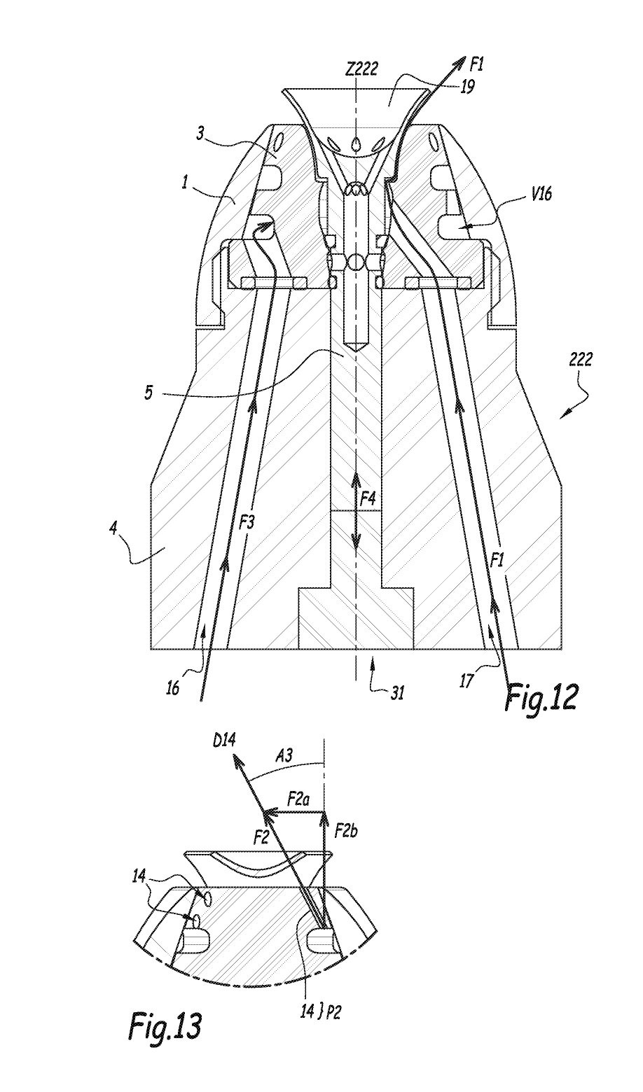

FIG. 13 is a partial sectional view along the line XIII-XIII in FIG. 10,

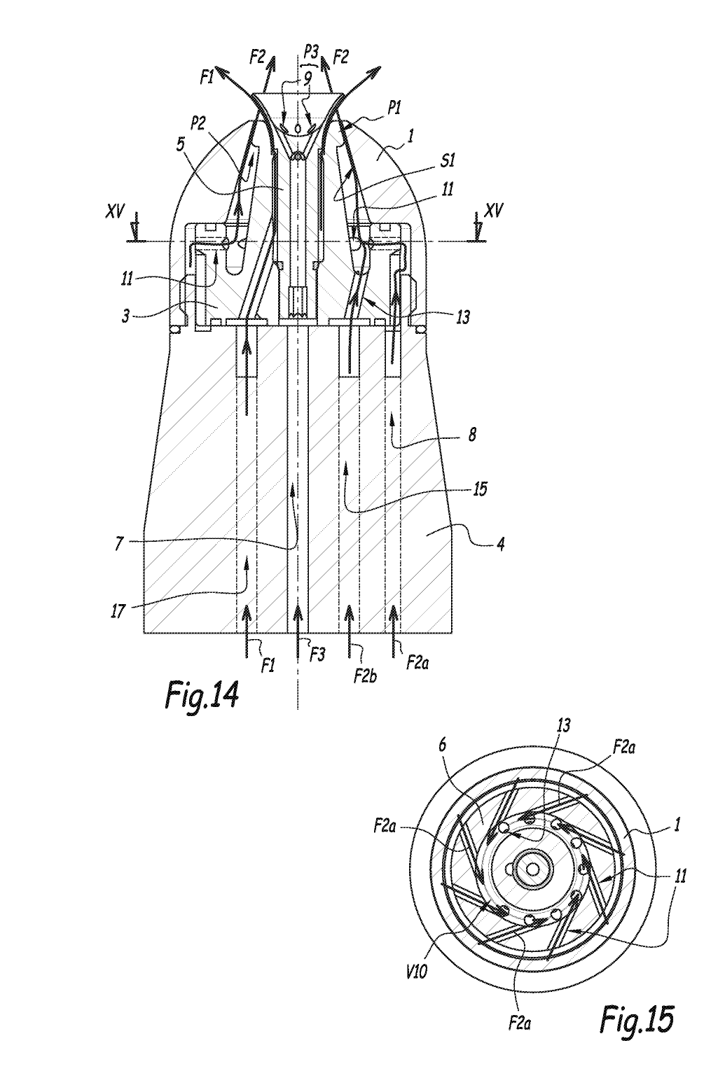

FIG. 14 is a longitudinal sectional view similar to FIG. 11 and at a smaller scale of a sprayer according to a third embodiment of the invention,

FIG. 15 is a sectional view along the line XV-XV of FIG. 14,

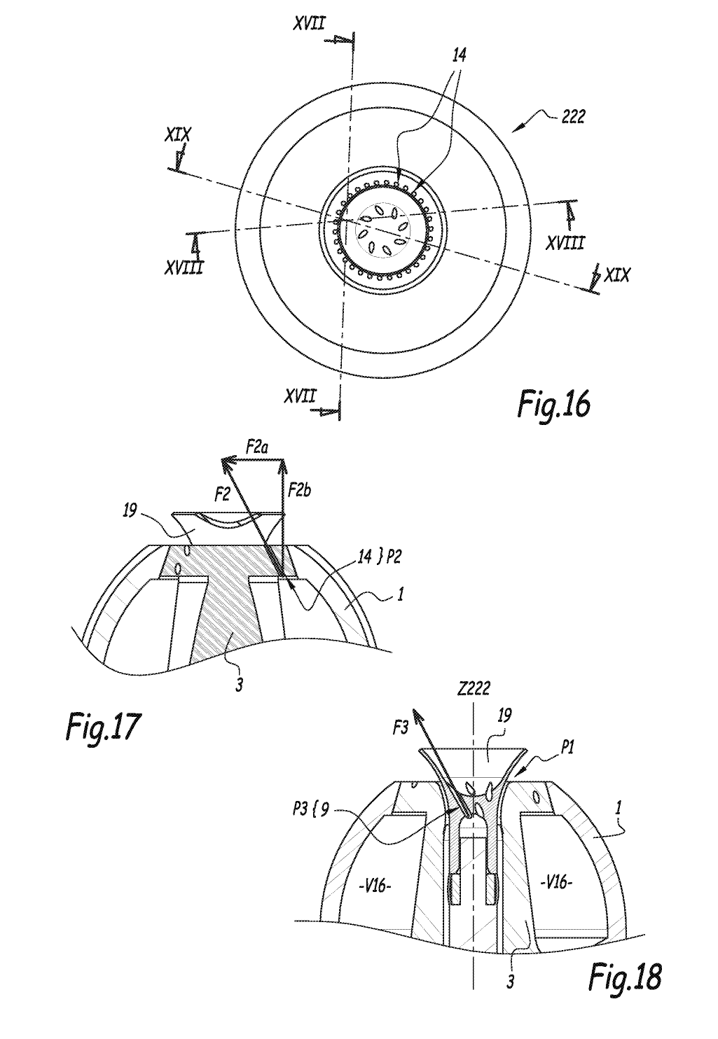

FIG. 16 is a view similar to FIG. 10, for a sprayer according to a fourth embodiment of the invention,

FIGS. 17 and 18 are sectional views along the lines XVII-XVII and XVIII-XVIII of FIG. 16, and

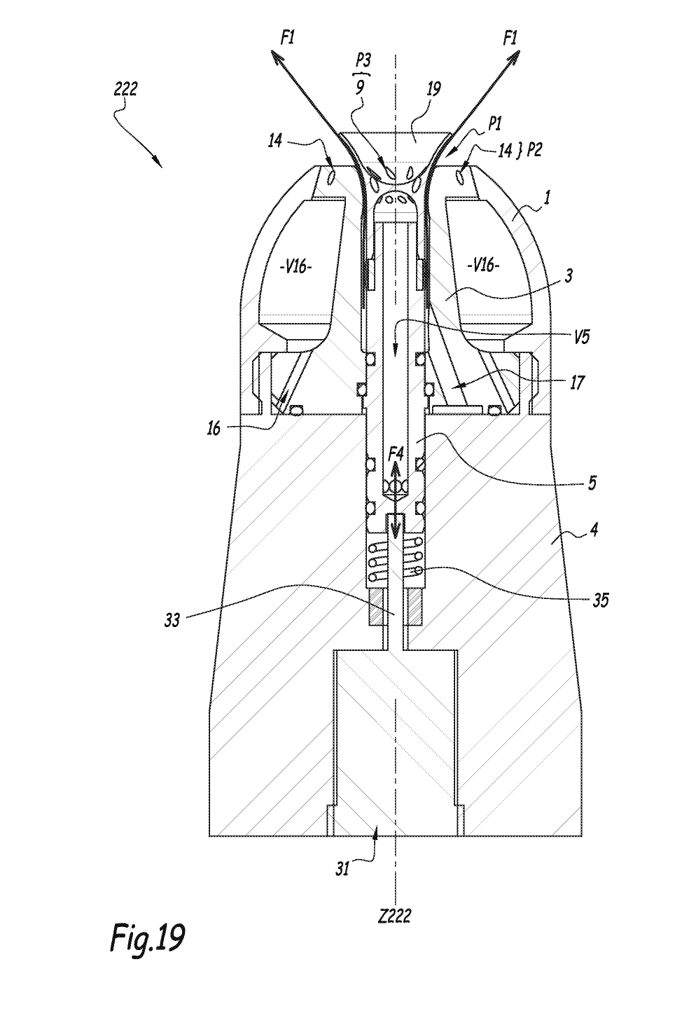

FIG. 19 is a sectional view at a larger scale along the line XIX-XIX of FIG. 16.

In FIG. 1, is illustrated a facility 2 for spraying a liquid coating product onto a part. In the example, this liquid coating product is liquid paint. The facility 2 comprises a confinement chamber 20 which gives the possibility of cleaning up the environment in the workshops, recovering and entirely recycling the paint which would not have attained the part(s) to be treated. For this purpose, the facility 2 comprises a pipe not shown, giving the possibility of draining the paint remaining inside the confinement chamber 20 towards the outside. This chamber 20 further prevents any external pollution and facilitates the transport of the paint droplets.

Inside the confinement chamber 20, are positioned several parts 26 intended to be treated. In practice, the parts 26 cover a path according to a direction perpendicular to the plane of FIG. 1 and according to which several types of sprayer are installed. For example, a water sprayer may be used for cooling the conformation tools and a liquid paint sprayer may then be used for coating the part with a paint layer. In an alternative not shown, a single wide part crosses the facility 2.

Above and below the parts 26 are positioned two modular sprayers 22 and 24. A modular sprayer is a sprayer comprising several modules, all supplied through a same supply line. In the following of the description, only the sprayer 22 is detailed in so far that the sprayers 22 and 24 are identical.

The modular sprayer 22 comprises two modules 222 and 223 and a parent block 220. The parent block 220 is a block which supplies with paint and with air the modules 222 and 223 of the sprayer 22. In practice, a spraying assembly may contain up to five modules. Thus, two spraying assemblies may include ten modules, which gives the possibility of spraying paint over a part with a width equal to about 1 meter. The parent block 220 is connected through pipes 28 to a paint and air supply block 25. Moreover, the parent block 220 is also connected through electric cables 21 to a unit for producing a high voltage 23, the function of which is detailed below. The high voltage production unit 23 and the paint and air supply block 25 are each connected to an electro-pneumatic control box 27.

The facility 2 further comprises a system for regulating paint and air flow rate, not shown in FIG. 1, but which is located upstream from the paint and air supply block 25. The flow rate regulating system gives the possibility of reducing paint consumption.

The module 222 of the sprayer 22 is only represented in FIG. 2, the module 222 is an axisymmetrical part around an axis Z222 which is the paint spraying axis.

In the following of the description, the terms of <<axial>> or <<axially>> refer to a direction parallel to the axis Z222, the terms of <<ortho-radial>> or <<tangentially>> refer to an ortho-radial direction to the axis Z222, i.e. a direction tangential to a circle centered on the Z222 axis, and the terms of <<top>>, <<bottom>>, <<upper>> and <<lower>> should be interpreted with respect to the Z222 axis, by being aware that the direction from bottom to top represents the paint ejection direction. Finally, the terms of <<inner>> and <<outer>> should be interpreted according to a radial direction to the Z222 axis.

This module 222 comprises an outer hood 1 which is hollow and with symmetry of revolution around the axis Z222 and inside which is co-axially positioned a nozzle 3 which is hollow. A core 5 is co-axially positioned inside the nozzle 3. The nozzle 3 and the core 5 are also parts which are globally axisymmetrical around the axis Z222. The outer axial surfaces of the top end of the nozzle 3 and of the core 5 are noted as S3 and S5. The surfaces S3 and S5 are flush with each other. On the other hand, the nozzle 3 and the core 5 each jut out from the hood 1, which results in the upper end of the hood 1 not being flush with the surfaces S3 and S5.

The nozzle 3 and the core 5 delimit between them a globally tubular space which represents a first passage P1 for the paint at the outlet of the module 222 of the sprayer 22. The first passage P1 is centered on the spraying axis Z222. Also, the nozzle 3 delimits, with the hood 1, a second passage P2 through which circulates air. Finally, holes 9 made inside the core 5 form a third air passage P3. This passage P3 may also have a ring-shaped section in a plane perpendicular to the Z222 axis. The passages P1 and P2 have a cross-section, i.e. perpendicular to the Z222 axis, with a shape of a ring, which results in that the passages P1 and P2 form concentric ring-shaped passage sections with respect to the Z222 axis when they are examined in the direction of the Z222 axis, while the passage P3 is a set of disconnected holes which are regularly distributed around of the Z222 axis.

When the sprayer 22 operates, the paint passes through the first passage P1 and forms a paint sheet L1 which is globally tubular and centered on the spraying axis Z222. The second passage P2 is crossed by air for conforming a first air sheet L2 which is also with a tubular geometry centered on the Z222 axis and which surrounds the paint sheet L1. Finally, as explained below, the holes 9 forming the third passage P3 conform a second air sheet L3 which is generally of a frusto-conical geometry centered on the Z222 axis, which is surrounded by the paint sheet L1 and which diverges in the direction of the spraying relatively to the Z222 axis. The air sheet L2 is an external air jet, while the air sheet L3 is an internal air jet relatively to the paint sheet L1. In FIG. 3, both air sheets are illustrated in solid lines, while the product sheet is illustrated in dashed lines.

As visible in FIG. 5, the module 222 comprises a base 4 which delimits air and paint connectors and which supports the nozzle 3 and the core 5. A skirt 6 is positioned co-axially inside the hood 1. This skirt 6 is globally axisymmetrical around the Z222 axis and comprises a first portion 6A which clasps an upper portion of the base 4, a second portion 6B which encircles a low portion of the nozzle 3 and a third connecting portion 6C of the first portion 6A with the second portion 6B, this third portion resting on the base 4. Further, the first portion 6A of the skirt 6 includes an upper rounded edge 6D, on which the hood 1 rests. Indeed, the hood 1 includes a beveled raised/recessed portion 1D which is adapted for resting against the upper edge of the portion 6A of the skirt 6.

As visible in FIG. 4, the connections each supply a paint or air passage conduit, from among which the outlet orifice of a conduit 7 gives the possibility of forming the air sheet L3 at the outlet of the core 5, the outlet orifices of the conduits 8 and 15 form together the air sheet L2 and the outlet orifice of a conduit 17 forms the paint sheet L1. The conduits 7, 15 and 17 cross the base 4 while the conduit 8 is defined between the hood 1 and the lower portion 6A of the skirt 6.

The core 5 includes an internal cavity, or internal space V5, which longitudinally extends along the Z222 axis. This cavity V5 communicates with the air passage conduit 7 at the inlet in the module 222 of the sprayer 22. Moreover, the core 5 comprises, at its upper end, the air passage holes 9. These holes 9 extend from the cavity V5 as far as the upper surface of the core 5, so that an air circulation flow F3 in the passage P3 first crosses the conduit 7, and then the cavity V5 and finally the holes 9 before being ejected from the core 5 in order to form the sheet L3.

The first air sheet L2 is formed within the module 222 in a chamber V10 which is located around of the upper portion 6B of the skirt 6. As better visible in FIG. 6, several holes open into this chamber V10. Among these holes, four holes 13 regularly distributed around the axis Z222, axially cross the portion 6C of the skirt 6 and open into the chamber V10. Thus, the air circulating in the holes 13 has an exclusively axial direction, i.e. parallel to the Z222 axis.

On the other hand, eight holes 11 also open into the chamber V10. These holes 11 cross the lower portion 6A of the skirt 6 and connect the passage conduit 8 to the chamber V10. Although they are visible in the background, two holes 11 are illustrated in dotted lines in FIG. 5 for showing the passage of the air towards the chamber V10. These holes 11 extend along a globally ortho-radial direction with respect to the Z222 axis. The chamber V10 is therefore a chamber for mixing the air arriving from the holes 11 and from the holes 13. This mixing results, within the chamber V10, in a whirl, which is at the origin of the <<vortex>> generated at the output of the module 222. The air then escapes upwards, between the hood 1 and the nozzle 3. Now, the hood 1 includes a top convergent portion towards the axis Z222. In other words, an internal bore S1 of this top terminal portion is frusto-conical and converges towards the central axis Z222.

The air circulating in the passage P2 forms an air sheet L2 which gradually moves away or diverges from the spraying axis Z222 in the direction of the spraying. This implies that the air sheet L2 drives the air surrounding the paint jet rotating around the axis Z222 and the paint jet L1 is sheared exteriorly.

Moreover, it is possible to adjust the air flow circulating in the holes 11 and 13 in order to adjust the orientation of the air at the outlet of the chamber V10. The mixing of the air arriving from the holes 11 and 13 forms an air sheet L2 which has a globally helical direction F2. In other words, the air sheet L2 is ejected with a direction F2 which includes an axial component F2b, which is generated by the holes 13 and an ortho-radial component F2a to the axis Z222, which is generated by the holes 11. Thus, by adjusting the air flow circulating in the holes 11 and 15, it is possible to modify the direction of the air at the outlet of the chamber V10 and therefore at the outlet of the sprayer 22. This is referred to as a vortex of a variable type. In practice, the ratio between the <<axial>> air flow and the <<ortho-radial>> air flow is comprised between 0% and 100%, notably of the order of 50%. A ratio of 0% results in a narrow directive jet and a straight air flow while a ratio of 100% results in a wide whirling jet and a vortexed air.

In the sectional plane of FIGS. 5, 7 and 8, the holes 9 made in the upper portion of the core 5 have an oval section. This indicates that the holes 9 extend along an oblique direction D9 relatively to the Z222 axis. More specifically, the direction D9 is divergent, relatively to the Z222 axis, in the direction of the ejection. Thus, the air circulating in the holes 9 is ejected so that the second air sheet L3 has a frusto-conical geometry which diverges in the direction of the spraying relatively to the Z222 axis. An angle between the direction D9 and the axis Z222 is noted as A1, this angle A1 is in practice comprised between 45° and 75°, preferably of the order of 60°.

Finally, the paint injected into the conduit 17 axially passes between the nozzle 3 and the core 5, which forms at the outlet of the nozzle a straight jet, i.e. the droplets of the sheet L1 are ejected parallel to the Z222 axis.

When the sprayer 22 operates, the paint sheet L1 is struck at a high speed by the internal air sheet L3 on the one hand and, exteriorly sheared by the external air sheet L2 on the other hand. Thus, the internal air sheet L3 gives the possibility of atomizing the paint sheet L1 as droplets, which improves the fineness of the spraying, while the external air sheet L2 drives the droplets of the jet L1 into rotation around the axis Z222, which gives the jet good stability.

The paint sheet L1 is therefore pinched between the first air sheet L2 and the second air sheet L3, which gives the possibility of thinning the thickness of the jet during the spraying. Finally, as the paint sheet L1 is struck or sheared on both sides, i.e. on its inner and outer radial surfaces, the result of this is a good distribution of the frictional forces of the air sheets L2 and L3 on the paint sheet L1, which allows homogenization of the size and of the distribution of the droplets within the paint jet.

As visible in FIG. 8, the module 222 contains a vibrator 31. This vibrator 31 is laid out axially below the core 5 and is in contact with the latter. This may be a vibrator of the piezoelectric type which operates by supplying an alternating current to a piezoelectric material with a predetermined frequency so as to deform it alternately in compression and in traction. These successive deformations of the vibrator 31 cause vibrations which propagate within the core 5 as illustrated by the arrow with two directions F4. Thus, perturbations appear within the paint sheet L1, which tends to breakdown the sheet L1 into droplets. The frequency of the vibrations of the vibrator 31 is adjusted according to the desired size of the droplets. This frequency is to be adjusted according to the geometry of the vibrating component and to the sought size of the drops. It is comprised between 20 and 150 Hz according to the used technology: piezoelectric, ultrasonic or other technology. This vibrator 31 is supplied with electric current by the high voltage production unit 23.

In FIGS. 9 to 13, is illustrated a second embodiment of a module 222 of a sprayer 22.

For the sake of clarity, in the embodiments which follow, only the differences with the first embodiment are described hereafter. Thus, the elements which do not have or few structural and functional differences with those of the sprayer of the first embodiment retain their reference while the elements which significantly differ at a structural or functional level bear other references.

Further, the internal, external air sheets and the product sheet are not illustrated for the embodiments of FIGS. 9 to 13 since they are similar to those illustrated in FIG. 3.

As visible in FIG. 9, the core 5 extends beyond the nozzle 3 and the hood 1 with a bowl 19. Thus, the free end of the core 5 is no longer flush with the free end of the hood 1 and of the nozzle 3. Nevertheless, the hood 1 in this embodiment is flush with the end of the nozzle 3. The bowl 19 has a bell-shaped geometry which is flared upwards relatively to the Z222 axis, i.e. in the spraying direction.

In this embodiment, the hood 1 is screwed into the upper portion of the base 4.

As visible in FIG. 10, the bowl 19 is perforated with eight holes 9 for letting through the air in order to form the air sheet L3. In a similar way to the first embodiment, the holes 9 communicate with an internal cavity V5 of the core 5 which extends parallel to the Z222 axis. The holes 9 diverge, relatively to the axis Z222, in the spraying direction. The holes 9 each extend along a direction D9 which is comprised in a plane containing the axis Z222 and which forms an angle A1 with the Z222 axis. In the example of the figures, the angle A1 is purely “radial” i.e. it is comprised in a plane containing the Z222 axis. This angle A1 is in practice comprised between 0° and 60°, preferably of the order of 45°. Thus the air ejected from the holes 9 tends to adhere to the inner surface of the bowl 19. Thus, the bowl 19 is advantageously cleanable by injecting a rinsing product into the third passage P3.

A supply conduit 7 conveys the air from the air supply block 25 as far as radial drill holes 7A which open within the cavity V5.

As visible in FIG. 12, the paint enters the module 222 through the conduit 17, crosses the nozzle 3 until it passes into a passage P1 positioned between the bowl 19 and the nozzle 3. The nozzle 3 encircles the bowl 19 so that the paint slides along the outer surface of the bowl 19 at the outlet of the module 222. Thus, the passage P1 has a geometry mating that of the bowl 19, i.e. flared upwards. Advantageously, by using a bowl 19 for guiding the paint jet at the outlet of the sprayer 22 it is possible to control the shape of the jet. Indeed, several bowl ranges may be used for modifying the width or the shape of the jet. The use of a bowl in a sprayer is known per se, but rather as extension of the nozzle of the sprayer. Indeed, in sprayers with a bowl of the prior art, the bowl is driven in rotation so that the product particles are flattened against the inner surface of the bowl by the centrifugal force. On the other hand, the sprayer 22 according to the invention comprises a fixed bowl 19 which forms an extension of the core 5. This is referred to as a sprayer with a stationary bowl. By using a stationary bowl, it is possible to get rid of the means for driving the bowl in rotation around the spraying axis, which makes the sprayer more compact, more reliable and more economical.

Unlike the first embodiment, this module 222 does not include any skirt inserted between the hood 1 and the nozzle 3. The injected air for forming the external air sheet is not mixed within an internal chamber of the module 222. Indeed, the air is ejected through holes 14 which cross the nozzle 3, which directly open towards the bowl 19 and which form an external air sheet having a globally helical direction. More specifically and with reference to FIGS. 12 and 13, the air flows in a passage conduit 16 crossing the base 4 until it arrives in a coil-shaped chamber V16, from which it escapes in order to pass into the holes 14. The holes 14 extend along a direction D14 which is both oblique relatively to the Z222 axis and tangential relatively to this Z222 axis. The direction D14 is comprised in a plane perpendicular to an axis radial to the Z222 axis and forms an angle A3 with an axis parallel to the Z222 axis. In the example of the figures, this angle A3 is purely <<ortho-radial>>, i.e. it is contained in a plane perpendicular to an axis radial to the axis Z222. The angle A3R is in practice comprised between −60° and +60°, preferably of the order of −45° or 45°. The angle A3R is in practice comprised between −30° and +30°, preferably 10°. Thus, the air flowing in the holes 14 comprises an axial component F2b and an ortho-radial component F2a. The whole of the holes 14 therefore defines the passage P2 for the air and gives to the resulting external air sheet, a helical direction around the axis Z222.

During operation, the paint sheet moves along the outer surface of the bowl 19 and then is exteriorly struck by the air sheet since the holes 14 are oriented towards the bowl 19. Thus, the paint sheet is maintained flattened against the bowl 19 and sees its thickness decrease under the pressure of the external air jet. Further, similarly to the first embodiment, the external air jet drives, by shearing, the paint jet into rotation around the Z222 axis in order to guide the paint jet towards the part to be treated and to make it more stable. Once the paint has reached the edge of the bowl 19, it is struck at a high velocity by an internal air sheet. The internal air sheet will therefore atomize the paint jet as droplets.

The bowl 19 has a relatively thin thickness, comprised between 0.5 mm and 2 mm, notably of the order of 1 mm so that the paint jet takes off from the bowl 19 through a thin edge. The paint droplets therefore have not much surface for adhering thereto, which improves the fluidity of the spraying.

The module 222 also comprises a vibrator 31 positioned in contact with the core 5. By vibrating the core 5, it is possible to enhance the atomization of the paint jet into droplets. Indeed, the vibrations generated within the paint jet cause turbulences leading to the formation of droplets. Here again, the frequency of the vibrations is adjusted depending on the desired size of the droplets. In practice, this frequency is comprised in the same range as that of the vibrator fitting out the sprayer 22 according to the first embodiment.

In FIGS. 14 and 15 a third embodiment of a sprayer 22 is illustrated. In this third embodiment, the skirt 6 and the nozzle 3 are in one piece, only the reference of the nozzle 3 is therefore pointed out in FIG. 14.

The sprayer 22 is distinguished from the sprayer of FIGS. 9 to 13 in so far that the external air sheet is, similarly to the sprayer of FIGS. 2 to 8, formed with a mixture of two airs within a chamber V10. More specifically and with reference to FIG. 15, an axial air intake opens into the chamber V10 through holes 13 and an ortho-radial air intake opens into the chamber V10 through holes 11. The mixing of both of these air intakes forms a vortex within the chamber V10, i.e. the air flows with a helical direction centered on the Z222 axis.

Similarly to the first embodiment, the hood 1 comprises an internal bore 51 which is of a frusto-conical shape and which converges upwards towards the Z222 axis.

In FIG. 14, the passage conduits 7, 8, and 15 are extended downwards in a dashed line since they are not visible in the sectional plane of FIG. 14. Also, the holes 11 of the <<ortho-radial>> air passage in the chamber V10 are also illustrated in dashed lines in the nozzle 3.

Moreover, the sprayer 22 according to the third embodiment does not include any vibrator.

In FIGS. 16 to 19, is illustrated a fourth embodiment of a module 222 of a sprayer 22. This latter embodiment does not differ very much from the second embodiment of FIGS. 9 to 13.

Like for the second embodiment, the external air sheet is formed by a set of holes 14 regularly distributed around the core 5. These holes 14 eject the air present in a chamber V16, which is supplied by a conduit 16. The holes 14 form a passage P2 for the air and are tilted so as to form a vortexed external air sheet, i.e. having a helical direction. This external air sheet will drive by shearing the paint jet which runs along a bowl 19 through a passage P1.

Further, some air is also ejected within the core 5 through holes 9 which eject the air arriving into a cavity V5. These holes 9 are divergent relatively to the Z222 axis, which generates an internal air sheet of frusto-conical shape inside the bowl 19. This internal air sheet will atomize the paint jet at the edge of the bowl 19. The paint jet is then sprayed as droplets.

Unlike the embodiment of FIGS. 9 to 13, the chamber V16 no longer has a coil shape but completely surrounds the nozzle 3 and communicates with several conduits 16 of the air passage. Further, the vibrator 31 includes a rod 33 which is supported in a notch positioned in the lower portion of the core 5 and a spring 35 which gives the possibility of enhancing the vibrations.

In an alternative not shown and applicable to the second, third and fourth embodiments, the tilt angle A1 of the holes 9 is not purely <<radial>>. Indeed, the angle A1 comprises, when it is projected into a plane containing the Z222 axis, a component A1R and, when it is projected into a plane perpendicular to the plane containing the Z222 axis, a component MT. In practice, the angle A1T is comprised between −60° and 60°, preferably of the order of 0° and the angle A1R is comprised between 0° and 60°, preferably of the order of 45°. Thus, it is possible to obtain a vortexed inner air sheet which is straight or divergent.

In an alternative not shown and applicable to the second and fourth embodiments, the tilt angle A3 of the holes 14 is not purely <<ortho-radial>>. Indeed, the angle A3 comprises, when it is projected into a plane containing the Z222 axis, a component A3R and, when it is projected in a plane perpendicular to the plane containing the Z222 axis, a component A3T. In practice, the angle A3T is comprised between −60° and 60°, preferably of the order of −45° or 0° and the angle A3R is comprised between −30° and 30°, preferably of the order of 10°. Thus, it is possible to obtain a straight, convergent or divergent vortexed outer air sheet relatively to the spraying axis Z222.

Alternatively, the vibrator 31 is of the magnetic, pneumatic or electric type.

In an alternative not shown, the vibrator 31 vibrates the nozzle 3 or the bowl 19.

In an alternative not shown, the internal air sheet is straight, i.e. the air is ejected from the third passage P3 along a direction parallel to the spraying axis.

In an alternative not shown, the external air sheet is straight, i.e. the air is ejected from the second passage P2 along a direction parallel to the spraying axis.

In an alternative not shown, the first passage P1 of the product is formed by several disconnected passage sections.

Alternatively, the sprayed product may be any liquid coating product, in particular:
an inorganic polymer, known under the generic name of sol, which is used in a sol-gel process,
an ink,
a lubricant,
a primer,
a base,
a varnish which may be diluted with water or containing a solvent, or further
water.

Alternatively, the external air sheet is not vortexed, i.e. it does not drive the product jet into rotation around the spraying axis Z222.

Alternatively, which may be applied to all the embodiments, the sprayer 22 is an electrostatic sprayer, which means that the part 26 to be treated is connected to ground while the ejected product particles of the sprayer 22 are electrostatically charged. An electrostatic field is generated then between the sprayer and the part to be treated, so as to channel the jet.

In an alternative not shown, the internal air sheet L3 is vortexed, i.e. the air ejected from the third passage P3 has a helical direction which may be oriented in the same direction as the direction of the external air sheet L2 or in the opposite direction.

In an alternative not shown, the internal air sheet L3 is ejected from a ring-shaped passage. Optionally, the air flowing in this passage has a divergent direction relatively to the Z222 axis. To do this, the core may for example include an internal bore, inside which air flows, which is frusto-conical and which diverges relatively to the Z222 axis in the direction of the spraying.

In an alternative not shown, the product sheet is also vortexed, in the same direction or in the opposite direction of the external air sheet.

In an alternative not shown, at least two parts from among the nozzle 3, the skirt 6, the hood 1, the base 4 and the core 5 are in one piece.

The alternatives and embodiments mentioned above may be combined together in order to obtain new embodiments of the invention.

1. A sprayer of a liquid coating product along a spraying axis, comprising:
a first passage of a product sheet, which is centered on the spraying axis, and
a second passage for ejecting an air sheet which co-axially surrounds the first passage,
a third passage for ejecting another air sheet which is co-axially positioned inside the first passage,
a nozzle centered on the spraying axis, and
a core, co-axially positioned inside the nozzle so that the first passage is defined between the core and the nozzle,
wherein the sprayer further comprises a vibrator which is capable of vibrating at least the nozzle or the core.

2. The sprayer according to claim 1, wherein, during operation, the third passage gives the other air sheet a divergent direction, relatively to the spraying axis, in a spraying direction.

3. The sprayer according to claim 1, wherein, during operation, the second passage gives the air sheet a divergent direction, relatively to the spraying axis, in a direction of the spraying.

4. The sprayer according to claim 1, wherein, during operation, at least one passage among the second passage and the third passage gives the air sheet or the other air sheet a helical direction relatively to the spraying axis.

5. The sprayer according to claim 4, wherein the sprayer comprises a chamber into which open:
at least one first air supply conduit, along an axial direction, and
at least one second air supply conduit, along an ortho-radial direction relatively to the spraying axis,
and which supplies the second passage.

6. The sprayer according to claim 4, wherein the sprayer comprises a chamber which is supplied through an air supply conduit and air ejection holes which are supplied by this chamber and which, during operation, together supply the air sheet.

7. The sprayer according to claim 1, wherein the vibrator uses an ultrasound technology.

8. The sprayer according to claim 1, wherein the core extends along the spraying axis and beyond the nozzle, with a bowl.

9. The sprayer according to claim 8, wherein the bowl has a bell shape which diverges, relatively to the spraying axis, in a direction of the spraying.

10. The sprayer according to claim 8, wherein the inside of the bowl may be cleaned by injecting a rinsing product into the third passage.

11. A facility for spraying a liquid coating product on a part, this facility comprising:
a confinement chamber,
a product supply block,
an electro-pneumatic control box, and
at least one sprayer of the product,
wherein the sprayer is according to claim 1.

12. The facility according to claim 11, wherein the sprayer is according to claim 5 and wherein the facility comprises means for adjusting the air flow in the first air supply conduit and in the second air reply conduit.
